(19) United States
(12) Patent Application Publication
(10) Pub. No.: US 2026/0099909 A1
(43) Pub. Date: Apr. 9, 2026

(54) SYSTEMS AND METHODS FOR DETECTING GROOVES IN BOREHOLE IMAGES USING TEMPORAL CONTINUITY

(71) Applicant: Schlumberger Technology Corporation, Sugar Land, TX (US)

(72) Inventors: Gurami Keretchashvili, Clamart (FR); Ana Julia Escobar, Clamart (FR); Ahmad Ahmad, Issy-les-Moulineaux (FR)

(21) Appl. No.: 18/905,285

(22) Filed: Oct. 3, 2024

(51) Int. Cl. G06T 7/00; G06T 7/11; G06T 7/73; G06V 10/26; G06V 10/774; G06V 10/776; G06V 20/50

(52) U.S. Cl. CPC G06T 7/0002; G06T 7/11; G06T 7/73; G06V 10/26; G06V 10/774; G06V 10/776; G06V 20/50; G06T 2207/20021; G06T 2207/20081; G06T 2207/20084

(57) ABSTRACT

Present embodiments are directed towards systems and methods including receiving borehole image data, segmenting the borehole image data into a plurality of patches, where each patch of the plurality of patches is representative of a fixed size segment of the borehole image data, determining one or more temporal dependencies between each patch and one or more surrounding patches of the plurality of patches, and generating, using a defect prediction model, defect identification image data representative of a continuous indication of a defect in a structure of a borehole based on the plurality of patches and the one or more temporal dependencies.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Corrosion-related failures pose significant risk and account for over a quarter of total well failures in the oil and gas industry. These failures can occur at various stages of a project's lifecycle and negatively impact operational performance and costs. Particularly, the corrosion of steel pipes due to harsh conditions in wellbores can lead to undesirable consequences, such as fluid leakage, operational downtime, and environmental impact. Therefore, monitoring well integrity throughout its lifecycle is beneficial to ensure timely intervention if any risks are detected.

Evaluating pipe conditions within a well involves characterizing corrosion, monitoring leaks and structural deficiencies, and detecting potential pipe breaks. Ensuring accurate corrosion detection is beneficial to reduce interpretation time, minimize subjectivity, and enhance overall performance. One of the primary challenges in accurately detecting these defects within deep wells is maintaining continuity in the predictions due to the depth that these wells often inhabit. As such, it may be desirable to develop techniques to train a machine learning model to detect these defects accurately while accounting for continuity of the defects along the entire length of the pipes of the wellbore.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, a system includes a computing system with one or more processors, memory, and instructions stored on the memory and executable by the one or more processors to perform operations including receiving borehole image data, segmenting the borehole image data into a plurality of patches, where each patch of the plurality of patches is representative of a fixed size segment of the borehole image data, determining one or more temporal dependencies between each patch and one or more surrounding patches of the plurality of patches, and generating, using a defect prediction model, defect identification image data representative of a continuous indication of a defect in a structure of a borehole based on the plurality of patches and the one or more temporal dependencies.

In certain embodiments, a method includes receiving borehole image data, segmenting the borehole image data into a plurality of patches, where each patch of the plurality of patches is representative of a fixed size segment of the borehole image data, determining one or more temporal dependencies between each patch and one or more surrounding patches of the plurality of patches, and generating, using a defect prediction model, defect identification image data representative of a continuous indication of a defect in a structure of a borehole based on the plurality of patches and the one or more temporal dependencies.

In certain embodiments, one or more tangible non-transitory computer-readable memory media, including processor-executable instructions that, when executed by one or more processors, cause the one or more processors to receive borehole image data, segmenting the borehole image data into a plurality of patches, where each patch of the plurality of patches is representative of a fixed size segment of the borehole image data, determine one or more temporal dependencies between each patch and one or more surrounding patches of the plurality of patches, and generate, using a defect prediction model, defect identification image data representative of a continuous indication of a defect in a structure of a borehole based on the plurality of patches and the one or more temporal dependencies.

The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a drilling system for drilling an earth formation, in accordance with certain embodiments;

FIG. 2 illustrates a block diagram of a borehole image analysis system that may be used to analyze borehole images captured for the drilling system of FIG. 1 as described in greater detail herein, in accordance with certain embodiments;

FIG. 3 illustrates an image of a pipe in a borehole and a cross-section of the pipe in the borehole, in accordance with certain embodiments;

FIG. 4 illustrates a two-dimensional (2D) mapping of an image presenting an exemplary axial groove defect associated with the cross-section of the pipes of FIG. 3, in accordance with certain embodiments;

FIG. 5 illustrates a comparison of the 2D mapping image, a labeled axial groove, and a predicted axial groove, in accordance with certain embodiments;

FIG. 6 illustrates a data processing pipeline for training a machine learning model to perform image analysis to detect axial grooves in the borehole, in accordance with certain embodiments;

FIG. 7 illustrates a method for generating artificial training data, in accordance with certain embodiments;

FIG. 8 illustrates exemplary artificial 2D mapping data as generated by the method illustrated in FIG. 7, in accordance with certain embodiments;

FIG. 9 illustrates an image of a segmented patch within the context of neighboring patches, in accordance with certain embodiments;

FIG. 10 illustrates an image of an exemplary window of segmented patches, in accordance with certain embodiments;

FIG. 11 illustrates a block diagram of a model training and identification framework associated with the data pipeline of FIG. 6, in accordance with certain embodiments;

FIG. 12 illustrates an image of varying confidence values associated with a predictive axial groove detection, in accordance with certain embodiments; and

FIG. 13 illustrates a method for preforming temporal bridging post-processing to the prediction axial groove of the machine learning model, in accordance with certain embodiments.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

As discussed above, defects, such as axial grooves within a surface of tubing or pipes, in wellbores may lead to a greater possibility of mechanical failure, fluid leakage, and/or operational downtime of a hydrocarbon extraction system. The condition of these wells may be actively monitored using sensor data to ensure timely intervention if any risks are detected. One of the primary challenges in detecting defects, such as axial grooves, within deep wells is maintaining continuity in the predictions. As such, the systems and methods described herein include a comprehensive segmentation framework for identifying axial grooves present in a well at the pixel level, while ensuring the preservation of continuity in the prediction results via the training of a machine learning model. Although axial grooves are one example of defects in a well (e.g., tubular, casing, pipe, etc.), the disclosed embodiments may include any surface defects in any direction along an interior surface and/or an exterior surface of tubing or pipes in a well or elsewhere. The defects may include grooves, scrapes, protrusions, cracks, cuts, or any combination thereof, that may be caused by tools, debris in a fluid flow, or any combination thereof. The defects may be elongated defects, a series of spaced defects, a plurality of parallel defects, or any combination thereof, along a central axis of the well (e.g., axial direction), around the central axis (e.g., circumferential direction), in a spiral or angled direction relative to the central axis, or any combination thereof.

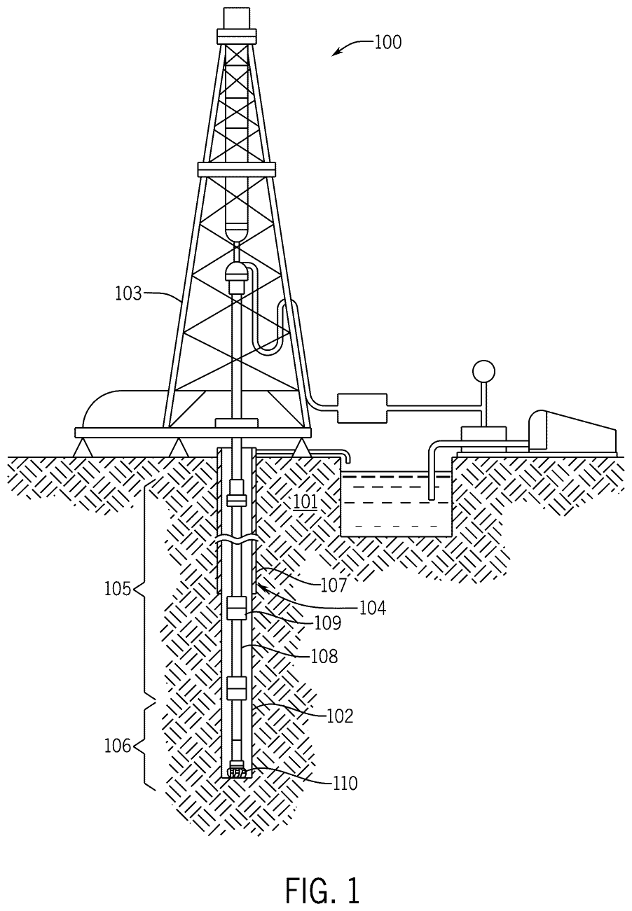

With the foregoing in mind, FIG. 1 shows one example of a hydrocarbon extraction system including a drilling system 100 that may use embodiments of defect monitoring and control as described in further detail below. The drilling system 100 includes various drilling equipment and tools for drilling a geological formation 101 to form a borehole 102. The drilling system 100 includes a drill rig 103 used to support and rotate a drilling tool assembly 104 that extends downward into the borehole 102. The drilling tool assembly 104 may include a drill string 105, a bottomhole assembly (“BHA”) 106, and a bit 110, attached to the downhole end of drill string 105.

The drill string 105 may include several joints of drill pipe 108 connected end-to-end through tool joints 109. The drill string 105 transmits drilling fluid through the borehole 102 and transmits rotational power from the drill rig 103 to the BHA 106. In some embodiments, the drill string 105 further includes additional components, such as subs, pup joints, and so forth. The drill pipe 108 provides a hydraulic passage through which drilling fluid is pumped from the surface. The drilling fluid discharges through nozzles, jets, or other orifices in the bit 110 and/or the BHA 106 for the purposes of cooling the bit 110 and cutting structures thereon, and for transporting cuttings out of the borehole 102.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing downhole well tools. The bit 110 may also include other cutting structures in addition to or other than a drill bit, such as milling or underreaming tools. In general, the drilling system 100 may include other drilling components and accessories, such as make-up/break-out devices (e.g., iron roughnecks or power tongs), valves (e.g., kelly cocks, blowout preventers, and safety valves), other components, or combinations of the foregoing. Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading formation or other downhole materials. For instance, the bit 110 may be a drill bit suitable for drilling the geological formation 101. Example types of drill bits used for drilling earth formations are fixed-cutter or drag bits, roller cone bits, and percussion hammer bits. In some embodiments, the bit 110 is an expandable underreamer used to expand a wellbore diameter. In other embodiments, the bit 110 is a mill used for removing metal, composite, elastomer, other downhole materials, or combinations thereof. For instance, the bit 110 may be used with a whipstock to mill into a casing 107 lining the borehole 102. The bit 110 may also be used to mill away tools, plugs, cement, and other materials within the borehole 102, or combinations thereof. Swarf or other cuttings formed by use of a mill may be lifted to surface, or may be allowed to fall downhole. In certain embodiments, a system and method for defect monitoring and control may be used to analyze borehole data, identify defects (e.g., axial grooves), and control one or more aspects of the hydrocarbon extraction system (e.g., drilling system 100, production system, etc.) based on the defects.

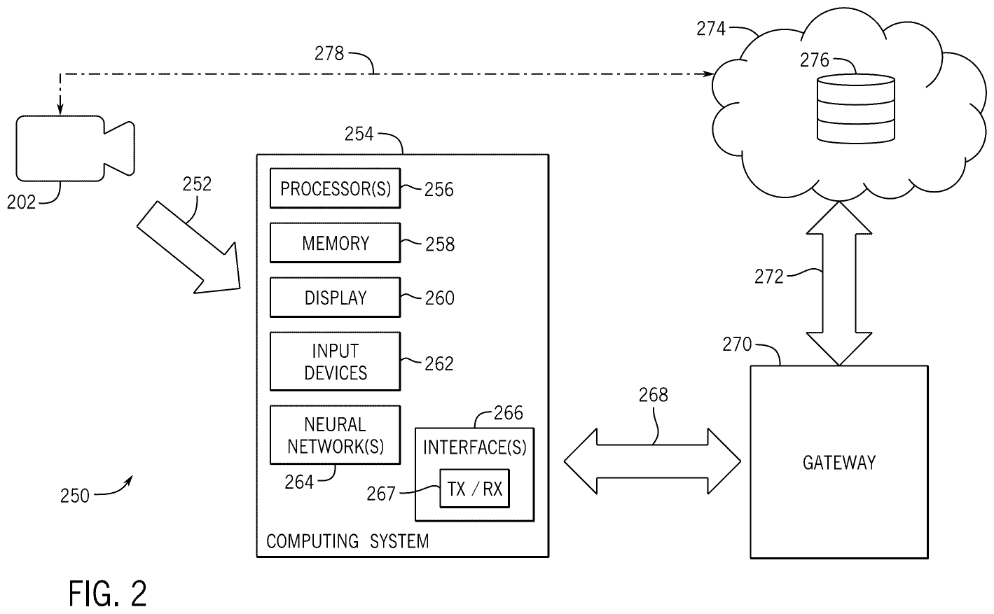

FIG. 2 is a block diagram of a borehole image analysis system 250 that may be used to analyze borehole data (e.g., borehole images or image data) captured for the drilling system 100 of FIG. 1 as described in greater detail herein. The borehole data may be received from an imaging tool 202 as input data 252 at a computing system 254. In some embodiments, the imaging tool 202 may include various types of image capturing sensors, such as electromagnetic imaging sensors, acoustic imaging sensors (e.g., ultrasonic imaging sensors), optical imaging sensors, thermal imaging sensors, and mechanic sensors. In certain embodiments, the imaging tool 202 may be implemented within a downhole tool (e.g., as part of a BHA 106) that may transmit the input data 252 as wired or wireless communications. In certain embodiments, the downhole tool that includes the imaging tool 202 may include any components discussed in relation to the computing system 254. Indeed, in certain embodiments, the computing system 254 may be and/or may include the downhole tool that includes the imaging tool 202. However, in other embodiments, the computing system 254 may be located at the surface of the drilling system 100 of FIG. 1. The various functional blocks shown in FIG. 2 may include hardware elements (including circuitry), software elements (including computer code stored on a tangible, non-transitory, computer-readable storage medium), or a combination of both hardware and software elements. It should be noted that FIG. 2 is merely one example of a particular implementation and is intended to illustrate the types of components that may be present in the computing system 254.

As illustrated, the computing system 254 may include one or more processor(s) 256, a memory 258, a display 260, input devices 262, one or more neural networks(s) 264, and one or more interface(s) 266. In the computing system 254, the processor(s) 256 may be operably coupled with the memory 258 to facilitate the use of the processors(s) 256 to implement various stored programs. Such programs or instructions executed by the processor(s) 256 may be stored in any suitable article of manufacture that includes one or more tangible, non-transitory, computer-readable storage media at least collectively storing the instructions or routines, such as the memory 258. The memory 258 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor(s) 256 to enable the computing system 254 to provide various functionalities. In some embodiments, the processor(s) 256 may be capable of generating, training, or refining models (e.g., a sinusoidal or fracture detection model as described herein). For example, the processors 256 may utilize machine learning and/or neural network techniques to generate, train, or refine the models.

The input devices 262 of the computing system 254 may enable a user to interact with the computing system 254 (e.g., pressing a button to increase or decrease a volume level). The interface(s) 266 may enable the computing system 254 to interface with various other electronic devices. The interface(s) 266 may include, for example, one or more network interfaces for a personal area network (PAN), such as a Bluetooth network, for a local area network (LAN) or wireless local area network (WLAN), such as an IEEE 802.11x Wi-Fi network or an IEEE 802.15.4 wireless network, and/or for a wide area network (WAN), such as a cellular network. The interface(s) 266 may additionally or alternatively include one or more interfaces for, for example, broadband fixed wireless access networks (WiMAX), mobile broadband Wireless networks (mobile WiMAX), and so forth.

In certain embodiments, to enable the computing system 254 to communicate over the aforementioned wireless networks (e.g., Wi-Fi, WiMAX, mobile WiMAX, 4G, LTE, and so forth), the computing system 254 may include a transceiver (Tx/Rx) 267. The transceiver 267 may include any circuitry that may be useful in both wirelessly receiving and wirelessly transmitting signals (e.g., data signals). The transceiver 267 may include a transmitter, a receiver, or a transmitter and a receiver combined into a single unit.

The input devices 262, in combination with the display 260, may allow a user to control the computing system 254. For example, the input devices 262 may be used to control/initiate operation of the neural network(s) 264. Some input devices 262 may include a keyboard and/or mouse, a microphone that may obtain a user's voice for various voice-related features, and/or a speaker that may enable audio playback. The input devices 262 may also include a headphone input that may provide a connection to external speakers and/or headphones.

In certain embodiments, the neural network(s) 264 may include hardware and/or software logic that may be arranged in one or more network layers. In certain embodiments, the neural network(s) 264 may be used to implement machine learning and may include one or more suitable neural network types. For instance, the neural network(s) 264 may include a perceptron, a feed-forward neural network, a multi-layer perceptron, a convolutional neural network, a long short-term memory (LSTM) network, a sequence-to-sequence model, and/or a modular neural network. In some embodiments, the neural network(s) 264 may include at least one deep learning neural network.

As discussed below, the output of the neural network(s) 264 may be based on the input data 252, such as metrics used to identify defects in borehole images, as described in greater detail herein. This output may be used by the computing system 254. Additionally or alternatively, the output from the neural network(s) 264 and/or the processor(s) 256 may be transmitted using a communication path 268 from the computing system 254 to a gateway 270. The communication path 268 may use any of the communication techniques previously discussed as available via the interface(s) 266. For instance, the interface(s) 266 may connect to the gateway 270 using wired (e.g., Ethernet) and/or wireless (e.g., IEEE 802.11) connections. The gateway 270 couples the computing system 254 to a wide-area network (WAN) connection 272, such as the Internet. The WAN connection 272 may couple the computing system 254 to a cloud network 274. The cloud network 274 may include one or more computing systems 254 grouped into one or more locations (e.g., data centers). The cloud network 274 includes one or more databases 276 that may be used to store the output of the neural network(s) 264. Indeed, in some embodiments, the imaging tool 202 (or the computing device that the imaging tool 202 is a part of) may send the input data 252 to the cloud 274 via connection 278 (e.g., Wi-Fi, cellular, and/or Internet connections). In such embodiments, the computing system 254 may be implemented in the cloud 274. Additionally or alternatively, at least some of the processing may be performed in the computing device that includes the imaging tool 202. In some embodiments, the cloud network 274 may perform additional transformations on the data using its own processor(s) 256 and/or neural network(s) 264. As such, all of the following steps discussed as performed in the computing system 254 may be performed in a computing system 254 that includes the imaging tool 202 (e.g., computing device 206), a computing system 254 that is separate from but receives image/video from the imaging tool 202, the cloud network 274, and/or any other suitable computing device.

As discussed above, during normal operation of the borehole 102, defects may arise within the tubing or pipes of the borehole 102. While there are multiple types of defects that may impact the operation of the borehole 102, particular interest is directed towards an axial groove defect. The axial grooves represent the loss of pipe material from corrosion, due to activities such as repetitive dragging of different tools used for operations in these wells. The axial grooves may span very large sections of the borehole 102 and thus may possess a continuous representation of the defect. Although the defects may include axial grooves in the following discussion, the disclosed embodiments include any types of defects in a surface of the borehole 102, or any other tubing or pipes, including but not limited to grooves, scrapes, protrusions, cracks, cuts, or any combination thereof, that may be caused by tools, debris in a fluid flow, or any combination thereof.

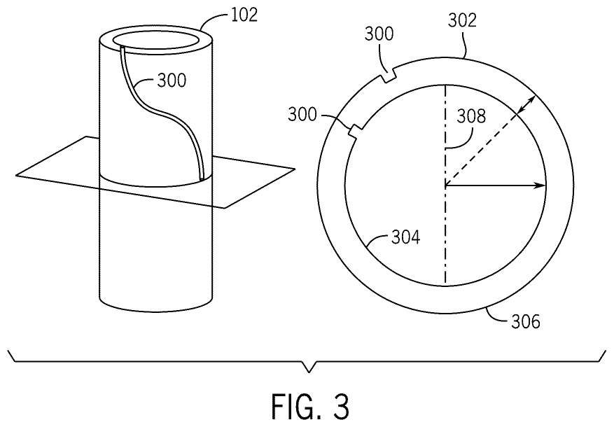

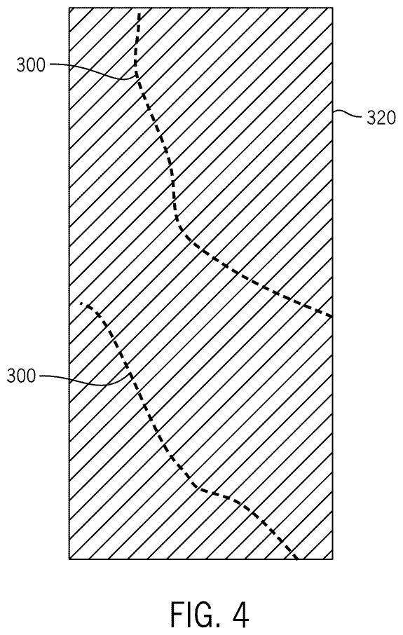

FIG. 3 illustrates an image of a pipe of the borehole 102 and a cross-section of the pipe, which may be output on a graphical user interface (GUI) of the display 260 of FIG. 2. As discussed above, the imaging tool 202 may capture data associated with the conditions of the borehole 102 and variations in a radial wall thickness 302 (e.g., thickness between inner annular surface 304 and outer annular surface 306) within the pipes of the borehole 102. As discussed above, the imaging tool 202 may capture an axial groove 300 present continuously throughout the exterior and interior of the pipes that make up the borehole 102, as illustrated in the cross-section image of FIG. 3. The axial groove 300 may extend generally along a central axis 308 of the borehole 102, although the axial groove 300 is not necessarily parallel to the central axis 308. In other words, the axial groove 300 may extend generally along the central axis 308, while also exhibiting some turns, angles, or the like relative to the central axis 308 as further illustrated in FIG. 4. For example, the axial groove 300 may result from scrapping a tool along the borehole 102, wherein the tool may twist within the borehole 102 causing the axial groove 300 to exhibit some spiral shape along the central axis 308 of the borehole 102. To ensure complete detection of these defects continuously, the computing system 254 may transform the data captured by the imaging tool 202 into a 2D mapping to simplify identification and tracking of the axial grooves 300.

With the foregoing in mind, FIG. 4 illustrates a 2D mapping 320 of an image presenting the exemplary axial groove 300 associated with the cross-section of the borehole 102 illustrated by FIG. 3. In some embodiments, the computing system 254 may generate the 2D mapping 320 of the cross-section of the borehole 102 based on the captured data from the imaging tool 202. As illustrated in FIG. 4, the axial groove 300 is marked by a continuous defect that is pronounced compared to its surroundings. The axial groove 300 illustrated in FIG. 4 is shown wrapping around (e.g., partially turning or spiraling in a circumferential direction around) the inner annular surface 304 of the pipe in the borehole 102, where the 2D mapping 320 shows the axial groove 300 as it continuously wraps around the borehole 102 along the vertical length of borehole 102. To produce the 2D mapping 320, raw sensor data from the imaging tool 202 is mapped through cylindrical-pipe dimensions in polar coordinates that represent the thickness of the pipe in the borehole 102. As a result, the 2D mapping 320 is presented such that the y-axis is depth (e.g., depth in a borehole or longitudinal distance along a central axis of a tubing or pipe) and the x-axis is the azimuth (e.g., circumferential direction around the central axis).

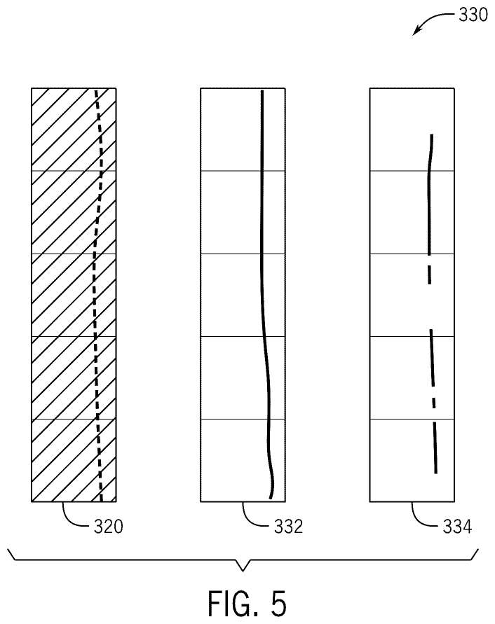

As discussed above, it is beneficial to identify these defects and ensure that the entire length of each axial groove 300 is properly tracked. As such, the usage of artificial intelligence and machine learning models are introduced to perform the difficult task of sorting through the noise produced by the imaging tool 202 to properly capture the axial groove 300. Due to the nature of the data captured by the imaging tool 202, it may be difficult to ensure correct identification and detection. The machine learning models may face obstacles correctly detecting the entirety of an identified axial groove due to the noise present in the data captured by the imaging tool 202 With the foregoing in mind, FIG. 5 illustrates a set of images representative of a discrepancy between an identified axial groove and a predicted axial groove as generated by the machine learning model. That is, FIG. 5 highlights a comparison between the 2D mapping 320, a labeled axial groove 332, and a predicted axial groove 334 as predicted by a machine learning model. It should be understood that the labeled axial groove 332 represents the actual location of the axial groove 300 as found in the 2D mapping 320.

As shown in FIG. 5, there is a discrepancy between the labeled axial groove 332 and the predicted axial groove 334. That is, the machine learning, without proper training, may produce the predicted axial groove 334 based on the 2D mapping 320, where the predicted axial groove 334 includes one or more discontinuities. This is starkly clear when comparing the labeled axial groove 332 to the predicted axial groove 334. One of the main challenges with a baseline approach is that it heavily lacks in the ability to detect the axial grooves 300 that are present in more challenging environments. For example, baseline machine learning models lack tools to utilize temporal information and mappings between different sections of the borehole 102. Due to this drawback, the machine learning model may produce the prediction axial groove 334, which illustrates a discontinuous detection across large sections of the borehole 102.

Additionally, there are a few additional challenges that may lead to discontinuous predictions. First, most of training data is limited, and the label class typically covers only about a small amount (e.g., 5-13%) pixels of the entire image, creating a large imbalance between a target class (i.e. the axial grooves 300) and background (e.g., interference, environmental factors, etc.). That is, the patterns present in the borehole 102 are not consistent, and in many cases, may have similar patterns or pixel intensities as the axial groove 300, generating background noise, causing the machine learning model to get distracted by these noisy areas. Finally, due to large variations between and within deep boreholes 102, the image in one section of the same borehole 102, may be significantly different from another section, posing the challenge of being able to adapt to a wide variety of cases.

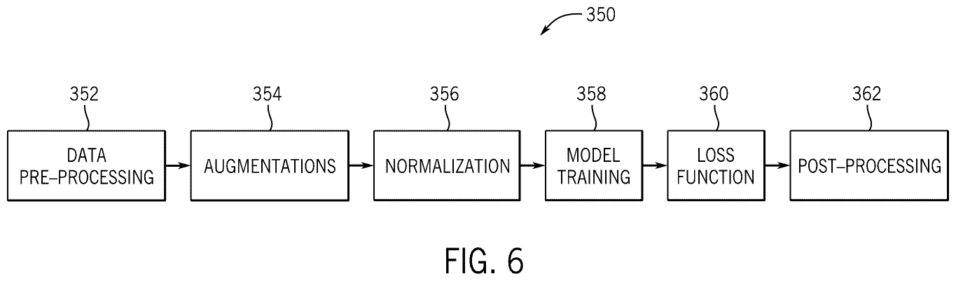

With the foregoing in mind, FIG. 6 illustrates a data processing pipeline 350 for training a machine learning model to perform image analysis to detect the axial grooves 300 in the borehole 102. In some embodiments, computing system 254 and its components (i.e., the processor 255) may utilize the framework of the data processing pipeline 350. It should be understood that the data processing pipeline 350 may operate in real-time, providing relevant output data in real-time.

At a data pre-processing block 352, the computing system 254 may prepare the captured data to conform with the correct format and dimensions for processing and training. Additionally, the computing system 254 may apply one or more data cleaning operations to handle outliers in the captured data and identify one or more enrichment opportunities to improve the variety of the captured data. As discussed above, the captured data may include the 2D mapping data 320, which has a long image length with a narrow width. As such, the computing system 254 may break the 2D mapping 320 into fixed size patches with dimensions of 36 patches by 36 patches, also known as image segmentation. In some embodiments, the computing system 254 may break the 2D mapping data 320 into one or more different configurations of dimensions to accommodate different processing methods. Due to segmenting the data in this way, the computing system 254 may handle the outliers and invalid start or end sections by measuring the median and standard deviations of the patch pixel intensities. The computing system 254 may apply a scalar to normalize the 2D mapping data 320.

As discussed above, there is a limited amount of training data that exists to train the machine learning model. The diversity of the boreholes 102 creates an obstacle where particularly difficult cases would be present in the testing set, while the training set may lack these kinds of similar cases, resulting in the machine learning model having to deal with situations that are very different from what it learnt from the training data. A particular example is when a pixel intensity of the axial groove 300 has a very high noise profile as the background distribution noise. This resulted in sections of the borehole 102, having a lot of background noise that distracts the model in terms of what to focus on in that section, as seen above in FIG. 5, where the predicted groove 334 does not match the labeled groove 332.

As such, the computing system 254 may increase the variety of training data by generating artificial 2D mapping data that resembles similar examples of background noise as found in the 2D mapping data 320. One technique to accomplish this is done via Fractal Perlin noise synthesis, which is a technique used in computer graphics and procedural generation to create more complex, natural-looking patterns and textures by combining multiple layers of Perlin noise at different frequencies and amplitudes. The noise is produced by interpolating between random gradients at grid points in a space, leading to a pattern that has both randomness and smooth transitions. In the context of fractal Perlin noise, the term ‘fractal’ may refer to the process of layering multiple ‘octaves’ of Perlin noise on top of each other to produce more complex patterns. Each octave is a Perlin noise function with different parameters, frequency (i.e., the rate at which the noise pattern changes, where higher frequencies result in more rapid changes, leading to finer details), amplitude (i.e., the height or intensity of the noise, where higher amplitudes lead to more significant variations in the noise value), and persistence (i.e., a parameter that determines how the amplitude decreases with each subsequent octave, where each octave has a lower amplitude than the previous one). Fractal Perlin noise is constructed by summing multiple octaves of Perlin noise as shown below in Equation 1, where n is the number of octaves, Perlin(x, y) is the Perlin noise function at a point (x, y), and aᵢ represents the amplitude for the i-th octave.

$$FractalNoise ( x , y ) = {\sum }_{1 = 0}^{n - 1} Perlin ( x \cdot {2}^{i} , y \cdot {2}^{i} ) \cdot {a}_{i} \qquad Equation 1$$

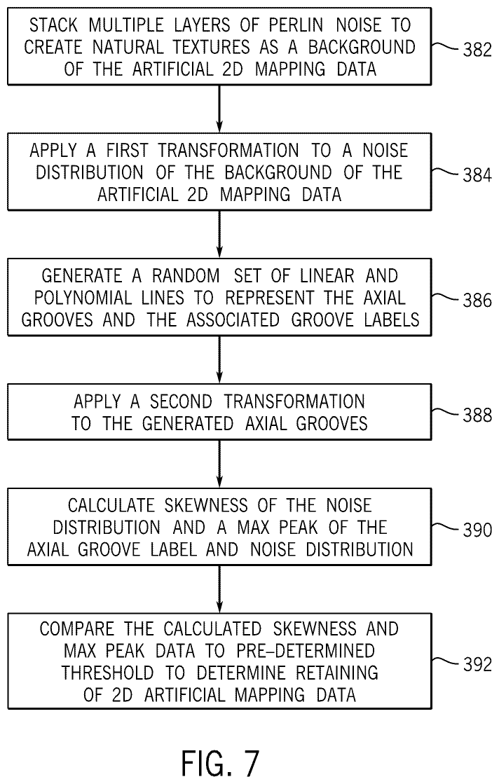

Accordingly, a method 380 for generating artificial training data is illustrated by FIG. 7, according to one or more embodiments of this disclosure. In general, certain process blocks performed in the method 380 may be performed by the processor 256 of the computing system 254. Moreover, certain process blocks described below may be performed in a different order than that illustrated, and, indeed, in some embodiments, certain process blocks may be skipped altogether. For simplicity, the below described method will be described as if being performed by the computing system 254.

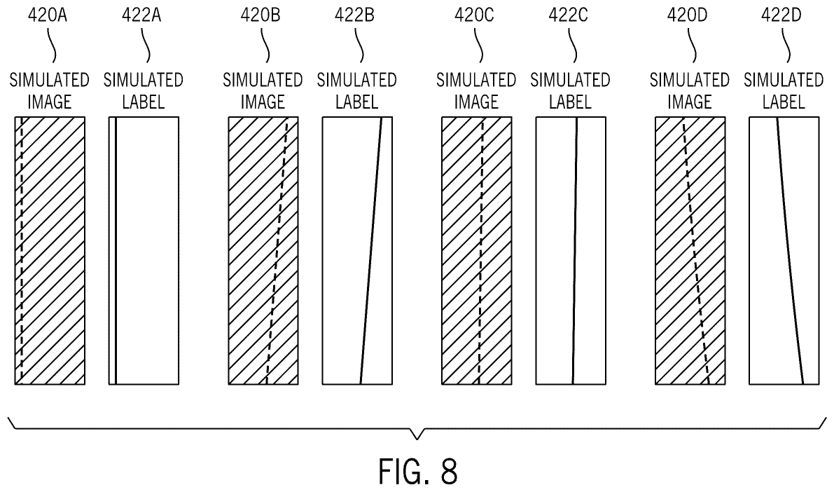

At step 382, the computing system 254 may stack multiple layers of Perlin noise to create natural textures as a background of the artificial 2D mapping data. The artificial 2D mapping data will be discussed shortly below in FIG. 8. At step 384, the computing system 254 may apply a first transformation to a noise distribution of the background of the artificial 2D mapping data. In some embodiments, the first transformation may include transforming the background into a Beta distribution to obtain a Platykurtic distribution.

At step 386, the computing system 254 may generate a random set of linear and polynomial lines to represent the axial grooves and the associated groove labels. At step 388, the computing system 254 may apply a second transformation to the generated axial grooves. In some embodiments, the second transformation may include transforming the axial grooves into a Student t-distribution to obtain a Leptokurtic distribution.

At step 390, the computing system 254 may calculate a skewness of noise in the background and a max peak of the groove label and the background to ensure consistent generation of applicable training data. That is, at step 392, the computing system 254 may compare the calculated skewness and max peak data to a pre-determined threshold and determine whether to retain the associated artificial 2D mapping data.

As briefly discussed above, examples of the associated artificial 2D mapping data are illustrated by FIG. 8. Each simulated image 420 may include background noise and an indication of each axial groove 300. The indication of each axial groove 300 is associated with a matching simulated groove label 422. Generating the simulated groove label 422 may allow sufficient training of the machine learning model. As such, simulated image 420A is associated with the simulated groove label 422A, simulated image 420B is associated with the simulated groove label 422B, simulated image 420C is associated with the simulated groove label 422C, and simulated image 420D is associated with the simulated groove label 422D. Each simulated image 422 illustrated by FIG. 8 represents an example case for identifying the axial groove present in the artificial 2D mapping data. The simulated images 420A-D are exemplary and do not encompass all possible options for artificial 2D mapping data.

Returning to FIG. 6, at the augmentation block 354, the computing system 254 may apply one or more image augmentations to the training data to increase the diversity of the training set and improve the robustness and generalizability of the machine learning model. It should be noted that the training data may include the retained artificial 2D mapping data in addition to any non-artificial 2D mapping data and their corresponding masks. By applying the one or more image augmentations, the computing system 254 may generate modified versions of existing 2D mapping data to allow the machine learning model to learn from a broader range of examples.

However, it is beneficial to maintain consistency between the augmented 2D mapping data and their corresponding segmentation masks, as misalignment may lead to incorrect conclusions by the machine learning model. Excessive augmentation may lead to overfitting and other obstacles. In some embodiments, the image augmentations may include roll, vertical flip, horizontal flip augmentation, and contrast distribution shift augmentation. At a normalization block 356, the computing system 254 may applying robust scalars to each patch segment to normalize the training data and prepare it for model training.

As discussed above, due to the multiple challenges present in the data, such as a large variety between class and background distributions, low contrast and significant background noise, common computer vision and image processing approaches for training the machine learning model to identify axial grooves are insufficient.

With this in mind, at a model training block 358 of FIG. 6, the computing system 254 may introduce temporality into the training of the machine learning model to provide the ability of patches to have memory preservation of surrounding neighbor patches. As such, in the case that a patch is much more difficult to interpret, contextual information from its neighboring patch feature maps may assist in passing beneficial information to the model, thus leading to overall improved feature map constructions per patch for the final segmentation. This leads to the machine learning model using a spatial-temporal approach where the patches and feature maps cover the spatial aspect, and the sequence of multiple patches (e.g., as a window) creates the temporal aspect due to the nature of the vertical depth of the borehole 102.

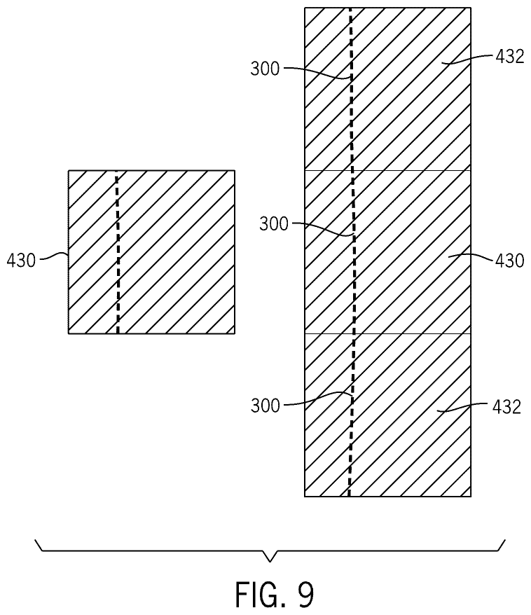

With the foregoing in mind, FIG. 9 illustrates an image of a selected patch 430 within the context of neighboring patches 432, where a selected patch 430 is interpreted in the context of neighboring patches 432. That is, the machine learning model may use the contextual information from the neighboring patches 432 to perform groove analysis on the selected patch 430. It should be noted that the contextual information from the neighboring patches 432 based on a temporal dependency between the selected patch 430 and each of the neighboring patches 432. The neighboring patches 432 may include any particular patch that is found within the 2D mapping image, both directly adjacent and not directly adjacent to the selected patch 430. By analyzing the temporal dependency between any set of patches, the machine learning model may make determinations when details regarding an axial groove are unclear in the selected patch 430. That is, the neighboring patches 432 may help clarify the location and continuity of the axial groove and/or distinguish background noise from the axial groove

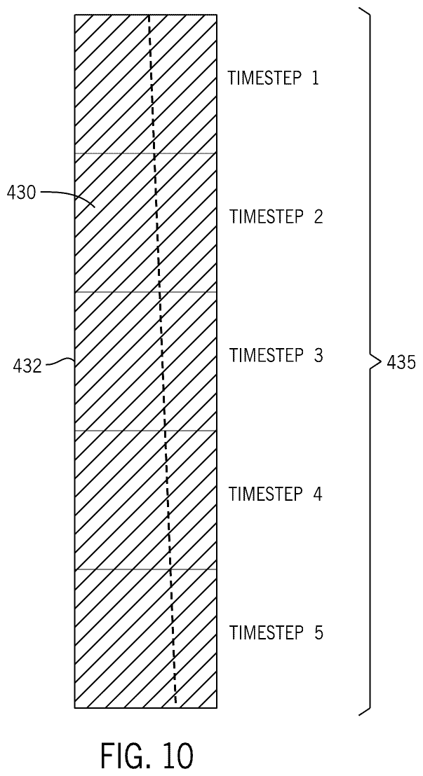

FIG. 10 illustrates an image of an exemplary window of segment patches. That is, the machine learning model may process one or more patches in a window 435. It should be noted that any of the patches may be the selected patch 430, which attributes the neighboring patches 432 to the patches surrounding the selected patch 430. In some embodiments, the window 435 may include a fixed set or number of patches 430, 432 connected to one another to be processed at a time. For example, as illustrated in FIG. 10, there are five patches 430, 432 that are processed as a group for the window 435. In certain embodiments, a group of 2, 3, 4, 5, 6, 7, 8, 9, 10, or more patches may be processed together in a group, such that neighboring patches provide contextual information. In other words, the model has a fixed window size that is adjustable as needed for a particular model configuration.

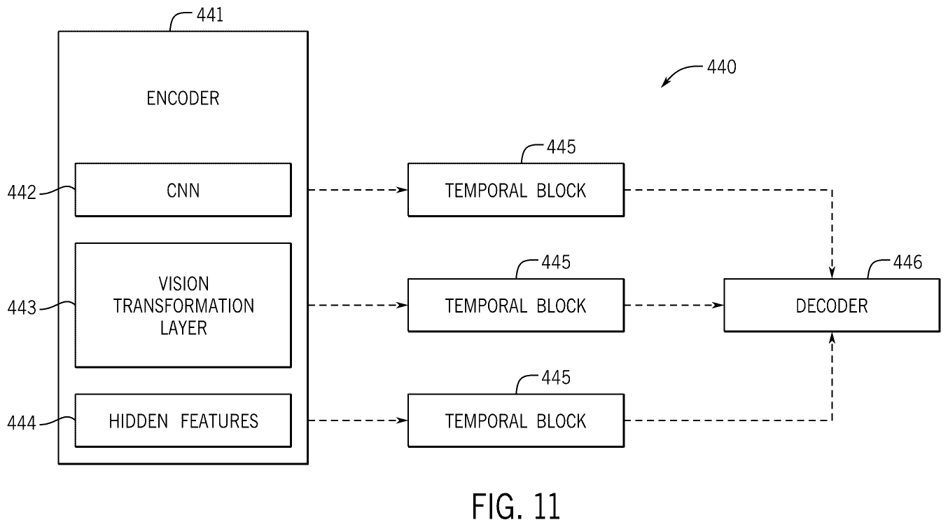

Returning to the model training block 358 of FIG. 6, the machine learning model may train using a hybrid technique of combining the strengths of both Convolutional Neural Networks (CNNs) and Transformers to leverage the local feature extraction capabilities of CNNs with the global context understanding provided by transformers. With the foregoing in mind, FIG. 11 illustrates a block diagram of a model training and identification framework 440 associated with the model training block 358. The model training framework 440 may include an encoder 441 with a CNN block 442, a vision transformation layer 443, and a hidden features block 444. The encoder 441 may communicate with a decoder 446 via one or more temporal blocks 445.

The integration of temporality is through the embedding of Bi-directional recurrent neural network as part of the temporal blocks 445 in specific areas of the overall encoder 441 and decoder 446 structure, specifically when data is being shared between the encoder 441 and decoder 446 through skip connections (discussed more below), as well as through the second last layer of the decoder 446.

By way of example, the machine learning model may use the encoder 441 to extract low-level feature maps through downsampling via the CNN block 442, increasing the abstract representations of the patches 430, 432. Given an image x= [symbol] ^{H×W×C}, the downsampling starts with increasing the channel depth to d=64. In the subsequent steps, the model goes through three stages of downsampling where the channel C is increased to C=2^{s}d, while both height H and width W is reduced to H,

$$W = \frac{1}{{2}^{s}} S ,$$

where s represents the downsampling stage. In this manner, the machine learning model may increase depth and reduce spatial features before proceeding to the visual transformation layer 443.

The resulting feature maps via the CNN block 442 is first tokenized by reshaping them into a sequence of 2D flattened tokens and each token is of size 1×1 where

$$N = \frac{HW}{{t}^{2}} ,$$

where t represents the token size, and N represents the total sequence length. The vectorized tokens are then mapped into a latent D-dimensional embedding space using the standard linear projection. Positional information is also encoded into the token embedding as shown below in Equation 2.

$${z}_{0} = [ {x}_{p}^{1} E ; {x}_{p}^{2} E ; … ; {x}_{p}^{N} E ] + {E}_{pos} \qquad Equation 2$$

The token embedding projection is represented as E∈ [symbol] ^{(p}^{²}^{·C)×D} and the position embedding is represented as Eₚₒₛ ∈ [symbol] ^{N×D}. The encoder 441 consists of a total of 6 vision transformer layers 443, each having Multihead Self-Attention (MSA) and the standard Multi-Layer Perceptron (MLP) blocks. The output for each layer [symbol] may be denoted as shown below in Equation 3.

$${z}_{ℓ}^{′} = MSA ( LN ( {z}_{ℓ - 1} ) ) + {z}_{ℓ - 1} \qquad Equation 3$$

$${z}_{ℓ} = MLP ( LN ( {z}_{ℓ}^{′} ) ) + {z}_{ℓ}^{′}$$

The layer normalization is denoted as LN(⋅) and the encoded image is represented as z [symbol] . The resultant hidden features are reshaped into C, H, W where C is doubled from the last stage of the CNN downsampled feature maps. Finally, a max pool layer (2×2 kernel) is applied to further reduce the dimensions H, W by half, before being upsampled in the decoder 446 stage.

With this in mind, the machine learning model may use one or more temporal blocks 445 to preserve and share memory between the patches 430, 432, while ensuring spatial context is conserved using the bi-directional recurrent neural network described above. It should be noted that the input to the machine learning model are patches 430, 432 with the shape (B,C,H,W) where B is the batch size, C is the channel, H is the height, and W is the width. To ensure that each window 435 is utilized in the temporal blocks, the machine learning model initially groups each set as the window 435 with five patches 430, 432 as illustrated in FIG. 10. As discussed above, the machine learning model may select any fixed number of patches 430, 432 to process within the window 435.

At the start of each temporal block 445, the machine learning model may reshape the batch of patches 430, 432 comprising the borehole 102 into the windows 435 with a shape of (B,T,C,H,W), where T represents the timestep of each patch 430 within each respective window 435. As such, the machine learning model may utilize a bi-directional approach to enable patches 430, 432 to share information from both directions. This also ensures that each patch 430 would get information from an equal number of neighboring patches 432. By way of example, when the window 435 is a sequence of five patches 430, 432, each patch 430 would get information from the other four patches 432. One or more hidden states from the forward and backward direction are linked to represent the final hidden state for each patch 430 in the window 435. These hidden states are then used as the updated feature maps extracted from the bi-directional recurrent neural network and reshaped back into the patches 430, 432 to proceed.

As discussed above, the machine learning model may use one or more skip connections to preserve spatial information during the encoding and decoding process. As the encoder 441 downsamples the input image, the encoder 441 may capture increasingly abstract and high-level features at the expense of fine-grained spatial details due to the pooling operations of the encoder 441. This loss of spatial resolution may degrade the quality of the segmentation, especially for fine structures. Skip connections may mitigate this issue by directly transferring feature maps from corresponding layers of the encoder 441 to the decoder 446. Specifically, feature maps from each downsampling layer of the encoder 441 are concatenated with the feature maps of the corresponding upsampling layer in the decoder 446. This allows the decoder 446 to use both the high-level features learned during downsampling and the fine-grained details preserved from the earlier layers. The inclusion of skip connections ensures that the machine learning model may produce high-resolution output with detailed boundaries, which is particularly important in tasks like image segmentation where precise localization is important.

As the feature map is passed through the skip connection, it first passes through the temporal block 450 to enable feature map sharing and improving the context for the patches 430, 432. The hidden states that are outputted from the temporal block 450 are then concatenated with the incoming feature map from the corresponding decoder 446. It should be noted that there is an additional temporal block 450 employed at the second last layer of the decoder 446 which is discussed further below.

The decoder 446 is responsible for reconstructing the output image, from the compressed feature representation produced by the encoder 441. This process involves gradually increasing the spatial resolution of the feature maps through a series of upsampling operations, in this case, implemented with transposed convolutions. The key aspect of the decoder 446 is its integration of skip connections from the encoder 441. The skip connections may carry feature maps from the corresponding layers of the encoder 441 directly into the decoder 446, allowing the machine learning model to combine both high-level, abstract features and fine-grained spatial details and in this case, with the involvement of temporal blocks, the decoder 446 may receive additional context information from neighboring patches 432 for each upsampling stage.

As the decoder 446 upsamples the feature maps, the concatenated information from the skip connections is refined through convolutional layers, helping to preserve and enhance the spatial details that are crucial for accurate segmentation. In this model architecture, there are four upsampling stages where the initial H,

$$W = \frac{1}{16} ,$$

and in each stage, the H, W are doubled in size until it reaches back to the original dimensions. At this stage, each patch has a channel size of 64, and the final temporal block 450 is integrated to assist in performing a final feature map memory share between neighbor patches 432. The resultant hidden states go through a final 1×1 convolution to bring the channel size back to the original size for the segmentation output.

Returning to FIG. 6, at a loss function block 360, the computing system 254 may use the output of the model training block 358 through a hybrid loss function to ensure that the machine learning model is trained correctly. That is, the hybrid loss function may be a combination of multiple loss functions. In one embodiment, the hybrid loss function may include two known loss functions, such as the Focal-Tversky loss function and the Centerline Dice Loss (“clDice”) function, while incorporating a novel loss function approach referred herein as the “Temporal Entropy Loss Function”. First, the computing system 254 may use the Focal-Tversky loss to ensure control of false negatives and to bring focus on hard cases for the model training to ensure class balance. Second, the computing system 254 may use the clDice function to help preserve the topological continuity within the axial grooves. Third, the computing system 254 may use the Temporal Entropy Loss Function to penalize the temporality within the model architecture. Each loss function plays a significant role and is given a certain weight that contributed to the overall hybrid loss function. The hybrid loss function may be represented below in Equation 4, where w_{{1,2,3}} are the weights associated with each loss function.

$$ℒ = {w}_{1} ( FocalTversky ) + {w}_{2} ( clDice ) + {w}_{3} ( Temporal Entropy ) \qquad Equation 4$$

The Focal Tversky and clDice loss functions do not require further discussion in the present context, although the third loss function, Temporal Entropy, is discussed below alongside an example illustrated by FIG. 11. Given the nature of the continuity of the axial grooves, the consecutive patches 430, 432 may include similarities with one another, such as the thickness or direction of the axial grooves between consecutive patches 430, 432. As such, it is beneficial to penalize the machine learning model for not identifying axial grooves of similar capacity within patches 430, 432 of each window 435, and in turn penalize the temporal aspect within the machine learning model.

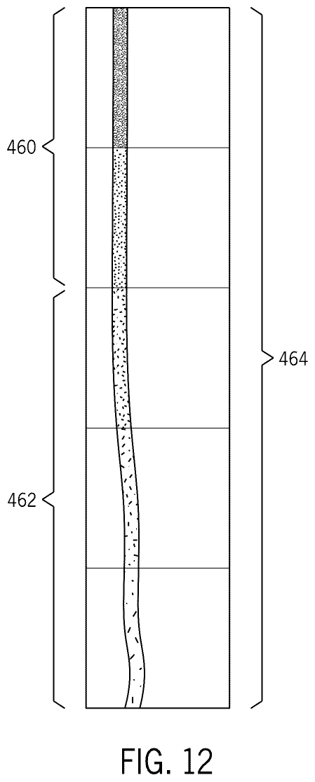

The computing system 254 may use Temporal Entropy loss to measure the randomness/uncertainty in the axial groove predictions for the patches 430 within the window 435. Upon determining that the patches 430, 432 are associated with a similar confidence in axial groove predictions, the loss is closer to 0. Conversely, when confidence between patches 430, 432 is more varied, loss increases, indicating that there is more difference in terms of what the machine learning model determines is present within the patches 430, 432 inside the window 435. With the foregoing in mind, FIG. 12 illustrates an image of varying confidence values associated with a predictive axial groove detection, where a first set of patches 460 and a second set of patches 462 are captured within a specific window 464. The axial groove 300 detected within the first set of patches 460 has a lower confidence value compared to the axial groove 300 detected within the second set of patches 462, as designated by the intensity of the shading of the axial groove 300 in each set.

Within each window, the computing system 254 may calculate the max confidence (for the target axial groove 300) per patch 430, and the set of confidence scores are transformed into a probability distribution. Next, the computing system 254 may calculate the normalized entropy for each window 435, which is subsequently averaged out across all windows 435. Finally, the computing system 254 may calculate loss as one subtracted from the averaged entropy. The overall equation is shown below in Equation 6.

$$PatchEntropy ( \hat{y} ) = - p ( max ( \hat{y} + ϵ ) \cdot {log}_{2} p ( max ( \hat{y} + ϵ ) ) \qquad Equation 6$$

$$TemporalEntropy ( \hat{y} ) = 1 - [ \frac{1}{w} {\sum }_{i = 1}^{W} \frac{{\sum }_{j = 1}^{P} - p ( max ( {\hat{y}}_{ij} + ϵ ) ) \cdot {log}_{2} p ( max ( \hat{y} + ϵ ) )}{{log}_{2} S} ]$$

It should be understood that y is the prediction tensor, W is the number of windows, P is the number of patches, p denotes the probability within the window, epsilon is the smoothing term, and S is the sequence length.

Returning to the data processing pipeline 350 of FIG. 6, at a post-processing block 362, the computing system 254 may perform post-processing on the segmentation outputs (e.g., sets of patches 430, 432 within respective windows 435) to refine and improve the segmentation outputs to produce the prediction axial groove 334. While segmentation models may effectively delineate different regions within an image, the results are often imperfect, exhibiting issues such as noise, jagged boundaries, and small, irrelevant regions. The post-processing block 362 addresses these issues by applying a series of techniques designed to enhance the accuracy, smoothness, and overall quality of the segmented regions. Due to the challenges presented by performing image analysis on the borehole 102, the computing system 254 may engage a novel post-processing technique called Temporal Bridging. This reduces false positives and closes any gaps to improve continuity and reduce false negatives.

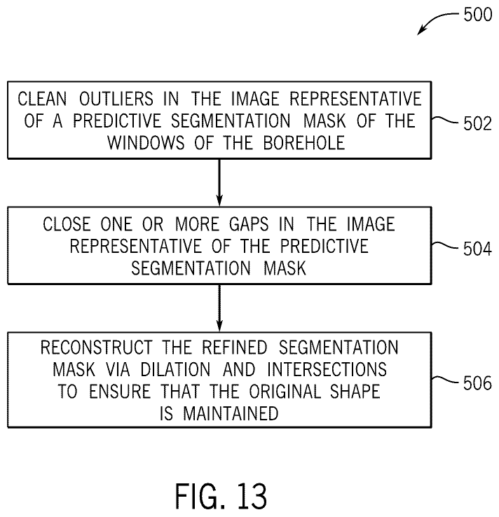

With the foregoing in mind, FIG. 13 illustrates a method 500 for performing temporal bridging post-processing to the prediction axial groove 334 of the machine learning model, according to one or more embodiments of this disclosure. In general, certain process blocks performed in the method 500 may be performed by the processor 256 of the computing system 254. Moreover, certain process blocks described below may be performed in a different order than that illustrated, and, indeed, in some embodiments, certain process blocks may be skipped altogether.

At block 502, the computing system 254 may clean outliers in the image representative of a predictive segmentation mask of the windows 435 of the borehole 102. That is, the computing system 254 may treat the segmentation as a time-series signal instead of the standard spatial context. To utilize the segmentation as a signal, the segmentation mask is first skeletonized (per borehole 102), and summed across each row, which results in a signal, where x values are represented from the row values of the image, and the y values are represented from the column values of the image. The outliers are removed using curve fitting to reduce false positives, that is particular points are kept/removed based on their location within or exterior to a specific boundary point. The interpolated points are additionally removed.

At block 504, the computing system 254 may close one or more gaps in the image representative of the predictive segmentation mask. The one or more gaps are representative of discontinuities in the predictive output generated by the machine learning model. That is, the computing system 254 may close the one or more gaps using interpolation to reduce false negatives and improve continuity. The computing system 254 may identify the one or more gaps and determine if a length of each gap falls within a particular range of values (i.e., less than a maximum gap length and/or less than a maximum start-end difference value). When a gap is flagged to be valid, the computing system 254 may perform spline interpolation and ensure the validity of each interpolation for each gap. When the computing system 254 detects a valid interpolation, that gap is closed. At block 506, the computing system 254 may reconstruct the refined segmentation mask via dilation and intersections to ensure that the original shape is maintained.

In some embodiments, the computing system 254 may analyze the output of the machine learning model to determine a severity of the defect associated with the detected axial groove 300. The computing system 254 may determine the severity of the defect based on one or more safety factors associated with the detected axial groove 300, where the one or more safety factors include length of defect, depth of defect, width of the defect, corrosion level associated with the defect, and any other suitable characteristics to describe the state of the defect and its impact on the structural integrity of the borehole 102. In certain embodiments, the computing system 254 may compare one or more parameters (e.g., length, width, and depth) of the defect against one or more thresholds (e.g., one or more length thresholds, one or more width thresholds, and one or more depth thresholds) to evaluate the severity of the defect. In certain embodiments, the computing system 254 may compare one or more parameters (e.g., distance from critical parts and spacing from other defects) of the defect against one or more thresholds (e.g., distance threshold and spacing threshold) to evaluate the severity of the defect. Accordingly, the computing system 254 may send a corresponding signal to one or more electronic devices indicating that the borehole 102 associated with the detected axial groove 300 is in need of maintenance and/or or shut down based on the severity of the defect.

The computing system 254 may generate structural damage indicators (e.g., notifications, reports, alerts, alarms, etc.) on an electronic display based on the location of the detected axial groove 300 to highlight which physical part of the structure of the borehole is experiencing the defect. In certain embodiments, the computing system 254 may generate an simulated image of the hydrocarbon system, including the wellbore, with a visual indication of the defects along the wellbore, where different colors, symbols, or labels depict changing severity of the defects along the wellbore. Additionally, the computing system 254 may determine one or more components, operating parameters, and/or environmental conditions associated with the drilling system 100 that caused and/or worsened the defects (e.g., detected axial groove 300). For example, the computing system 254 may determine a relationship or correlation between the defect and one tool of a plurality of tools (e.g., downhole tools, drilling tools, etc.) used in the wellbore, and identify operating parameters of the tool that may have resulted in the defect and/or worsened the severity of the defect.

As a further advantage, the computing system 254 may determine one or more corrective actions and/or adjustments to operation of the tool to reduce further defects and/or reduce the severity of the defects either in the future and/or in real-time while operating the tool in the wellbore. The computing system 254 also may adjust and/or control one or more operating parameters of the hydrocarbon system (e.g., drilling system) based on various aspects of the defect, including the severity of the defect, thereby helping to reduce risks caused by the defect, enable sufficient time to schedule maintenance at a future time, and/or reduce the possibility of additional defects. Furthermore, the computing system 254 may control various components of the hydrocarbon system based on the severity of the defect, such as adjusting the fluid flow rate, adjusting valve positions, adjusting a speed of a tool, adjusting a direction or steering of a tool, and so forth. In certain embodiments, the computing system 254 may issue one or more commands to adjust drilling operations and/or production operations associated with the drilling system 100 of FIG. 1. By way of example, the one or more commands may include operations for controlling the drilling equipment during drilling (e.g., drilling speed, direction, downward pressure, drill rotation speed, etc.), controlling various tools associated with the BHA 106 during deployment to minimize additional damage, and controlling production equipment during production.

The technical effect of the disclosed embodiments include techniques for training a machine learning model to detect defects accurately while accounting for continuity of the defects along the entire length of the pipes of the wellbore. For example, it is presently recognized that the presence of one or more defects in the structure of the borehole as found in the borehole image data may result in failure of a well and negatively impact operational performance and costs. Accordingly, by accurately detecting continuous defects in the borehole image data, the disclosed techniques may prevent waste of operational resources and mitigate dangerous failures associated with the defects.

The subject matter described in detail above may be defined by one or more clauses, as set forth below.

A system, comprising: a computing system comprising one or more processors, memory, and instructions stored on the memory and executable by the one or more processors to perform operations comprising: receiving borehole image data; segmenting the borehole image data into a plurality of patches, wherein each patch of the plurality of patches is representative of a fixed size segment of the borehole image data; determining one or more temporal dependencies between each patch and one or more surrounding patches of the plurality of patches; and generating, via a defect prediction model, defect identification image data representative of a continuous indication of a defect in a structure of a borehole based on the plurality of patches and the one or more temporal dependencies.

The system of any preceding clause, wherein the plurality of patches form a two-dimensional (2D) mapping of the borehole image data.

The system of any preceding clause, comprising: determining a severity of the defect based on the defect identification image data, wherein the severity of the defect is associated one or more safety factors associated with the defect, wherein the one or more safety factors comprise a length of defect, a depth of defect, corrosion level associated with the defect, or any combination thereof; generating a status representative of the severity of the defect, wherein the signal is representative of a status of the borehole; and initiating one or more actions to address the defect in the borehole of a hydrocarbon system wherein the one or more actions comprise an adjustment to equipment of the hydrocarbon system, a shut down action, a maintenance action, a borehole inspection action, or any combination thereof

The system of any preceding clause, comprising training the defect prediction model with non-artificial training data and artificial training data to identify the defect in the structure of the borehole, wherein generating the artificial training data comprises: layering one or more noise layers representative of background noise associated with the artificial training data; generating a random set of lines to represent the defect in the structure of the borehole; determining a defect label representative of an actual location of the defect in the artificial training data; calculating a skewness value based on background noise and a maximum peak value based on of the defect label and the background noise; comparing the skewness value and the maximum peak value with a pre-determined threshold; upon determining the skewness value and the maximum peak value exceed the pre-determined threshold, retaining the artificial training data; and upon determining the skewness value and the maximum peak value is below the pre-determined threshold, discarding the artificial training data.

The system of any preceding clause, comprising applying one or more temporal bridging post-processing operations to the defect identification image data, wherein the one or more temporal bridging post-processing operations comprise: identifying outlier data in the defect identification image data modifying the outlier data based on a boundary point in the defect identification image data, wherein the outlier data exterior to the boundary point is removed; identifying one or more gaps in the continuous indication of the defect in the defect identification image data; applying one or more interpolation operations to fill the one or more gaps in the continuous indication of the defect; and generating refined defect identification image data.

The system of any preceding clause, wherein determining the one or more temporal dependencies each patch and the plurality of patches comprises: identifying one or more characteristics of a specific patch of the plurality of patches; determining a temporal position of the specific patch in relation to each additional patch of the plurality of patches, wherein the temporal position of the specific patch is representative of a position of a captured area of the structure of the borehole in the borehole image data; and appending the temporal position to the one or more characteristics.

The system of any preceding clause, wherein the one or more characteristics comprise a batch size, a channel size, a height, a width, or any combination thereof.

The system of any preceding clause, comprising: identifying, via the defect prediction model, one or more discontinuities in detection of the defect in the defect identification image data; retrieving, via the defect prediction model, contextual information for each patch associated with the one or more discontinuities, wherein the contextual information is representative of the temporal position of each patch in relation to the one or more surrounding patches; and updating the defect identification image data based on the contextual information.

The system of any preceding clause, comprising determining, via a temporal entropy loss function, a confidence value associated with the continuous defect present in each patch of the plurality of patches in the defect identification image data, wherein: upon determining the confidence value associated with the identified continuous defects for each patch is below a confidence threshold, sending negative feedback to the defect prediction model; and upon determining the confidence value associated with the identified continuous defects for each patch is above the confidence threshold, sending positive feedback to the defect prediction model.

A method, comprising receiving, via one or more processors, borehole image data; segmenting, via the one or more processor, the borehole image data into a plurality of patches, wherein each patch of the plurality of patches is representative of a fixed size segment of the borehole image data; determining, via the one or more processor, one or more temporal dependencies between each patch and one or more surrounding patches of the plurality of patches; and generating, via a defect prediction model, defect identification image data representative of a continuous indication of a defect in a structure of a borehole based on the plurality of patches and the one or more temporal dependencies.

The method of any preceding clause, comprising forming, via the one or more processors, a two-dimensional (2D) mapping of the borehole image data based on the plurality of patches and the one or more temporal dependencies.

The method of any preceding clause, comprising determining, via one or more processors, a severity of the defect based on the defect identification image data, wherein the severity of the defect is associated one or more safety factors associated with the defect, wherein the one or more safety factors comprise a length of defect, a depth of defect, corrosion level associated with the defect, or any combination thereof; generating, via one or more processors, a status representative of the severity of the defect, wherein the signal is representative of a status of the borehole; and initiating, via one or more processors, one or more actions to address the defect in the borehole of a hydrocarbon system wherein the one or more actions comprise an adjustment to equipment of the hydrocarbon system, a shut down action, a maintenance action, a borehole inspection action, or any combination thereof.

The method of any preceding clause, comprising training, via the one or more processors, the defect prediction model with non-artificial training data and artificial training data to identify the defect in the structure of the borehole, wherein generating the artificial training data comprises: layering one or more noise layers representative of background noise associated with the artificial training data; generating a random set of lines to represent the defect in the structure of the borehole; determining a defect label representative of an actual location of the defect in the artificial training data; calculating a skewness value based on background noise and a maximum peak value based on of the defect label and the background noise; comparing the skewness value and the maximum peak value with a pre-determined threshold; upon determining the skewness value and the maximum peak value exceed the pre-determined threshold, retaining the artificial training data; and upon determining the skewness value and the maximum peak value is below the pre-determined threshold, discarding the artificial training data.

The method of any preceding clause, comprising applying, via the one or more processors, one or more temporal bridging post-processing operations to the defect identification image data, wherein the one or more temporal bridging post-processing operations comprise: identifying outlier data in the defect identification image data modifying the outlier data based on a boundary point in the defect identification image data, wherein the outlier data exterior to the boundary point is removed; identifying one or more gaps in the continuous indication of the defect in the defect identification image data; applying one or more interpolation operations to fill the one or more gaps in the continuous indication of the defect; and generating refined defect identification image data.

The method of any preceding clause, comprising determining, via a temporal entropy loss function, a confidence value associated with the continuous defect present in each patch of the plurality of patches in the defect identification image data, wherein: upon determining the confidence value associated with the identified continuous defects for each patch is below a confidence threshold, sending negative feedback to the defect prediction model; and upon determining the confidence value associated with the identified continuous defects for each patch is above the confidence threshold, sending positive feedback to the defect prediction model

The method of any preceding clause, wherein the one or more characteristics comprise a batch size, a channel size, a height, a width, or any combination thereof.

The method of any preceding clause, comprising identifying, via the defect prediction model, one or more discontinuities in detection of the defect in the defect identification image data; retrieving, via the defect prediction model, contextual information for each patch associated with the one or more discontinuities, wherein the contextual information is representative of the temporal position of each patch in relation to the one or more surrounding patches; and updating the defect identification image data based on the contextual information.

The method of any preceding clause, comprising determining, via a temporal entropy loss function, a confidence value associated with the continuous defect present in each patch of the plurality of patches in the defect identification image data, wherein: upon determining the confidence value associated with the identified continuous defects for each patch is below a confidence threshold, sending negative feedback to the defect prediction model; and upon determining the confidence value associated with the identified continuous defects for each patch is above the confidence threshold, sending positive feedback to the defect prediction mode.

One or more tangible non-transitory computer-readable memory media, comprising: processor-executable instructions that, when executed by one or more processors, cause the one or more processors to receive borehole image data; segment the borehole image data into a plurality of patches, wherein each patch of the plurality of patches is representative of a fixed size segment of the borehole image data; determine one or more temporal dependencies between each patch and one or more surrounding patches of the plurality of patches; and generate, via a defect prediction model, defect identification image data representative of a continuous indication of a defect in a structure of a borehole based on the plurality of patches and the one or more temporal dependencies.

The one or more tangible non-transitory computer-readable memory media of any preceding clause, wherein the instructions that, when executed by the one or more processors, cause the one or more processors to form a two-dimensional (2D) mapping of the borehole image data based on the plurality of patches and the one or more temporal dependencies.

The one or more tangible non-transitory computer-readable memory media of any preceding clause, wherein the instructions that, when executed by the one or more processors, cause the one or more processors to determine a severity of the defect based on the defect identification image data, wherein the severity of the defect is associated one or more safety factors associated with the defect, wherein the one or more safety factors comprise a length of defect, a depth of defect, corrosion level associated with the defect, or any combination thereof; generate a status representative of the severity of the defect, wherein the signal is representative of a status of the borehole; and initiate one or more actions to address the defect in the borehole of a hydrocarbon system wherein the one or more actions comprise an adjustment to equipment of the hydrocarbon system, a shutdown action, a maintenance action, a borehole inspection action, or any combination thereof.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a computing system comprising one or more processors, memory, and instructions stored on the memory and executable by the one or more processors to perform operations comprising:
receiving borehole image data;
segmenting the borehole image data into a plurality of patches, wherein each patch of the plurality of patches is representative of a fixed size segment of the borehole image data;
determining one or more temporal dependencies between each patch and one or more surrounding patches of the plurality of patches; and
generating, via a defect prediction model, defect identification image data representative of a continuous indication of a defect in a structure of a borehole based on the plurality of patches and the one or more temporal dependencies.

2. The system of claim 1, wherein the plurality of patches form a two-dimensional (2D) mapping of the borehole image data.

3. The system of claim 1, comprising:
determining a severity of the defect based on the defect identification image data, wherein the severity of the defect is associated one or more safety factors associated with the defect, wherein the one or more safety factors comprise a length of defect, a depth of defect, corrosion level associated with the defect, or any combination thereof;
generating a status representative of the severity of the defect; and
initiating one or more actions to address the defect in the borehole of a hydrocarbon system wherein the one or more actions comprise an adjustment to equipment of the hydrocarbon system, a shut down action, a maintenance action, a borehole inspection action, or any combination thereof.

4. The system of claim 1, comprising training the defect prediction model with non-artificial training data and artificial training data to identify the defect in the structure of the borehole, wherein generating the artificial training data comprises:
layering one or more noise layers representative of background noise associated with the artificial training data;
generating a random set of lines to represent the defect in the structure of the borehole;
determining a defect label representative of an actual location of the defect in the artificial training data;
calculating a skewness value based on background noise and a maximum peak value based on of the defect label and the background noise;
comparing the skewness value and the maximum peak value with a pre-determined threshold;
upon determining the skewness value and the maximum peak value exceed the pre-determined threshold, retaining the artificial training data; and
upon determining the skewness value and the maximum peak value is below the pre-determined threshold, discarding the artificial training data.

5. The system of claim 1, comprising applying one or more temporal bridging post-processing operations to the defect identification image data, wherein the one or more temporal bridging post-processing operations comprise:
identifying outlier data in the defect identification image data
modifying the outlier data based on a boundary point in the defect identification image data, wherein the outlier data exterior to the boundary point is removed;
identifying one or more gaps in the continuous indication of the defect in the defect identification image data;
applying one or more interpolation operations to fill the one or more gaps in the continuous indication of the defect; and
generating refined defect identification image data.

6. The system of claim 1, wherein determining the one or more temporal dependencies each patch and the plurality of patches comprises:
identifying one or more characteristics of a specific patch of the plurality of patches;
determining a temporal position of the specific patch in relation to each additional patch of the plurality of patches, wherein the temporal position of the specific patch is representative of a position of a captured area of the structure of the borehole in the borehole image data; and
appending the temporal position to the one or more characteristics.

7. The system of claim 6, wherein the one or more characteristics comprise a batch size, a channel size, a height, a width, or any combination thereof.

8. The system of claim 6, comprising:
identifying, via the defect prediction model, one or more discontinuities in detection of the defect in the defect identification image data;
retrieving, via the defect prediction model, contextual information for each patch associated with the one or more discontinuities, wherein the contextual information is representative of the temporal position of each patch in relation to the one or more surrounding patches; and
updating the defect identification image data based on the contextual information.

9. The system of claim 1, comprising determining, via a temporal entropy loss function, a confidence value associated with the continuous defect present in each patch of the plurality of patches in the defect identification image data, wherein:
upon determining the confidence value associated with an identified continuous defects for each patch is below a confidence threshold, sending negative feedback to the defect prediction model; and
upon determining the confidence value associated with the identified continuous defects for each patch is above the confidence threshold, sending positive feedback to the defect prediction model.

10. A method, comprising:
receiving, via one or more processors, borehole image data;
segmenting, via the one or more processor, the borehole image data into a plurality of patches, wherein each patch of the plurality of patches is representative of a fixed size segment of the borehole image data;
determining, via the one or more processor, one or more temporal dependencies between each patch and one or more surrounding patches of the plurality of patches; and
generating, via a defect prediction model, defect identification image data representative of a continuous indication of a defect in a structure of a borehole based on the plurality of patches and the one or more temporal dependencies.

11. The method of claim 10, comprising forming, via the one or more processors, a two-dimensional (2D) mapping of the borehole image data based on the plurality of patches and the one or more temporal dependencies.

12. The method of claim 10, comprising:
determining, via one or more processors, a severity of the defect based on the defect identification image data, wherein the severity of the defect is associated one or more safety factors associated with the defect, wherein the one or more safety factors comprise a length of defect, a depth of defect, corrosion level associated with the defect, or any combination thereof;
generating, via one or more processors, a status representative of the severity of the defect; and
initiating, via one or more processors, one or more actions to address the defect in the borehole of a hydrocarbon system wherein the one or more actions comprise an adjustment to equipment of the hydrocarbon system, a shut down action, a maintenance action, a borehole inspection action, or any combination thereof.

13. The method of claim 10, comprising training the defect prediction model with non-artificial training data and artificial training data to identify the defect in the structure of the borehole, wherein generating the artificial training data comprises:
layering one or more noise layers representative of background noise associated with the artificial training data;
generating a random set of lines to represent the defect in the structure of the borehole;
determining a defect label representative of an actual location of the defect in the artificial training data;
calculating a skewness value based on background noise and a maximum peak value based on of the defect label and the background noise;
comparing the skewness value and the maximum peak value with a pre-determined threshold;
upon determining the skewness value and the maximum peak value exceed the pre-determined threshold, retaining the artificial training data; and
upon determining the skewness value and the maximum peak value is below the pre-determined threshold, discarding the artificial training data.

14. The method of claim 10, wherein determining the one or more temporal dependencies each patch and the plurality of patches comprises:
identifying one or more characteristics of a specific patch of the plurality of patches;
determining a temporal position of the specific patch in relation to each additional patch of the plurality of patches, wherein the temporal position of the specific patch is representative of a position of a captured area of the structure of the borehole in the borehole image data; and
appending the temporal position to the one or more characteristics.

15. The method of claim 14, wherein the one or more characteristics comprise a batch size, a channel size, a height, a width, or any combination thereof.

16. The method of claim 14, comprising:
identifying, via the defect prediction model, one or more discontinuities in detection of the defect in the defect identification image data;
retrieving, via the defect prediction model, contextual information for each patch associated with the one or more discontinuities, wherein the contextual information is representative of the temporal position of each patch in relation to the one or more surrounding patches; and
updating the defect identification image data based on the contextual information.

17. The method of claim 10, comprising determining, via a temporal entropy loss function, a confidence value associated with the continuous defect present in each patch of the plurality of patches in the defect identification image data, wherein:
upon determining the confidence value associated with the identified continuous defects for each patch is below a confidence threshold, sending negative feedback to the defect prediction model; and
upon determining the confidence value associated with the identified continuous defects for each patch is above the confidence threshold, sending positive feedback to the defect prediction mode.

18. One or more tangible non-transitory computer-readable memory media, comprising: processor-executable instructions that, when executed by one or more processors, cause the one or more processors to:
receive borehole image data;
segment the borehole image data into a plurality of patches, wherein each patch of the plurality of patches is representative of a fixed size segment of the borehole image data;
determine one or more temporal dependencies between each patch and one or more surrounding patches of the plurality of patches; and
generate, via a defect prediction model, defect identification image data representative of a continuous indication of a defect in a structure of a borehole based on the plurality of patches and the one or more temporal dependencies.

19. The one or more tangible non-transitory computer-readable memory media of claim 18, wherein the instructions that, when executed by the one or more processors, are configured to cause the one or more processors to form a two-dimensional (2D) mapping of the borehole image data based on the plurality of patches and the one or more temporal dependencies.

20. The one or more tangible non-transitory computer-readable memory media of claim 18, wherein the instructions that, when executed by the one or more processors, are configured to cause the one or more processors to:
determine a severity of the defect based on the defect identification image data, wherein the severity of the defect is associated one or more safety factors associated with the defect, wherein the one or more safety factors comprise a length of defect, a depth of defect, corrosion level associated with the defect, or any combination thereof;
generate a status representative of the severity of the defect; and
initiate one or more actions to address the defect in the borehole of a hydrocarbon system wherein the one or more actions comprise an adjustment to equipment of the hydrocarbon system, a shut down action, a maintenance action, a borehole inspection action, or any combination thereof.
